(19) United States
(12) Patent Application Publication
(10) Pub. No.: US 2011/0010418 A1
(43) Pub. Date: Jan. 13, 2011

(54) PVR OFFLOADER

(76) Inventor: Greg J. Lipinski, Fort Collins, CO (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/865,271

(22) PCT Filed: Mar. 7, 2008
(86) PCT No.: PCT/US08/56205

§ 371 Date: Jul. 29, 2010

(51) Int. Cl. G06F 15/16

(52) U.S. Cl. 709/203; 709/223

(57) ABSTRACT

System and method for offloading and sharing content stored on a storage device of a personal video recorder (PVR) uses an offloader agent that runs on the PVR to provide content stored on the PVR storage device. A server having a server storage device receives, stores, and serves the provided content. A storage manager runs on the server for managing storage space of the server storage device. A communications mechanism connects the PVR storage device to the server storage device via a data communications network.

### BACKGROUND

A personal video recorder (PVR), also called a digital video recorder (DVR), is a device that records video in a digital format to a hard drive or other medium. Typically, a PVR is a so-called set top box containing a hard disk drive, which enables video capture and playback to and from the drive. The PVR operates under the control of instructions running on a processor, for example, instructions loaded with an operating system into memory from a storage device such as a hard drive. The PVR generally is located near a viewing device such as a television and is connected to it via a cable connection, such as RCA connectors. A television signal typically comes into a built-in tuner in the PVR, such as through an antenna or cable. The signal then typically goes into a digital encoder, which converts the signal to a digital format, such as MPEG-2, suitable for storage. From the encoder, the signal is typically sent to the hard drive for storage, and to an MPEG-2 decoder, which converts the signal back to a form suitable for the television for viewing. Thus, the PVR hard drive is the recording medium.

The PVR has been gaining in popularity, especially in comparison to the VCR. This may be because a PVR provides viewing capabilities that a VCR cannot. For example, a VCR uses a video cassette as the recording medium. Typically, a video cassette can only record a few hours of video. The cassette then needs to be exchanged for another, and a collection of cassettes needs to be stored. In contrast, a PVR stores information on an internal hard drive that can hold many hours of video, typically from about 40 hours to hundreds of hours, depending on the size of the drive. Furthermore, a PVR can provide freeze frame and instant reply capabilities on a program as it is received, which a VCR cannot do. A PVR can also jump directly to any location in stored content, whereas a VCR must wind the tape to the desired content location for viewing.

However, unlike a VCR where virtually unlimited storage is provided simply by acquiring more tapes, adding storage space to a PVR is typically not possible. Therefore, a PVR has a limited amount of content it can record and store. Although the capacity of hard drives used in PVRs has increased, the effectiveness of those increases has been offset by increases in the amount of data that need to be stored when recording high definition programs. Furthermore, content stored in a PVR can typically be accessed and played only by that PVR. There is no way to share content stored on one PVR with another.

### BRIEF DESCRIPTION OF THE DRAWINGS

The accompanying drawings, which are Included to provide a further understanding of the invention and are incorpotated in and constitute a part of this specification, illustrate embodiments of the Invention and together with the description serve to explain the principles of the invention.

In the drawings:

FIG. 1 is a block diagram of a system for offloading and sharing content stored on a PVR.

FIG. 2 shows a method of offloading content stored on a PVR to a server and viewing the offloaded content.

FIG. 3 shows a method for use in an embodiment of the disclosed system and method.

FIG. 4 shows a method of managing newly recorded content in accordance with the disclosed system and method.

FIG. 5 shows a method of sharing content stored on a server.

### DETAILED DESCRIPTION

Reference will now be made in detail to the disclosed embodiments, an example of which is illustrated in the accompanying drawings. The disclosed system and method provide the ability to transparently offload content stored on a PVR to a networked server, while still providing full access and management of the content by the PVR application. They also provide the ability to share content stored on the server for viewing on multiple viewing devices, such as televisions or computer monitors. When the content has been offloaded from a PVR to the server, it can be accessed and potentially played (depending on digital tights management (DRM) controls) via other PVRs and/or PCs on the network.

It is to be understood that both the foregoing general description and the following detailed description are intended to be exemplary and explanatory and not limiting, and are intended to provide further explanation of the disclosed system and method.

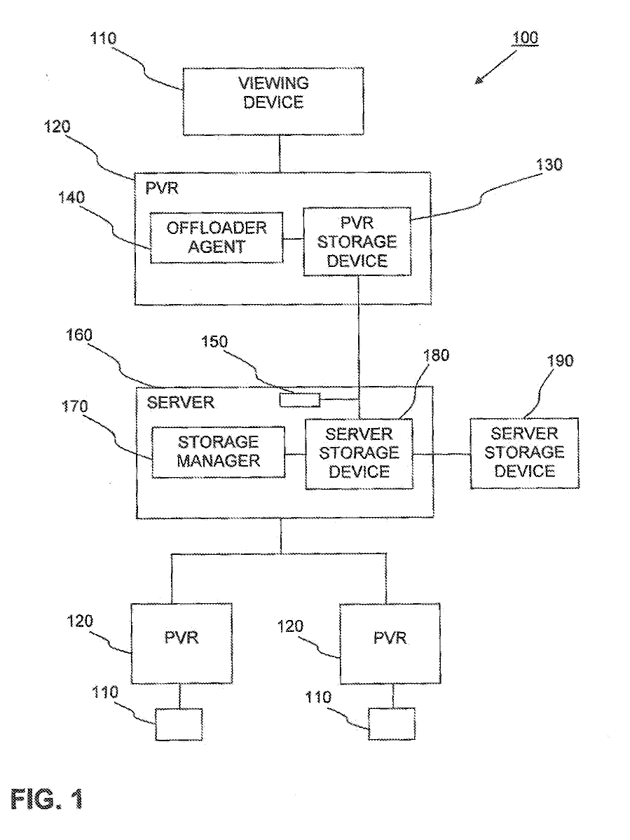

Referring now to FIG. 1, shown is an exemplary system 100 for offloading and sharing content stored on a PVR. As is shown, viewing device 110 is provided with recorded viewable content such as recorded shows and the like stored on PVR storage device 130 in PVR 120. PVR storage device 130 is typically a hard disk drive, but can comprise any combination of any type of readable/writable non-volatile random access storage devices, such as one or more recordable optical disks, hard drives, flash drives, or the like. PVR 120 has an offloader agent 140 that runs on the PVR. Also provided is a communications mechanism 150, used to establish communications between the PVR and a server 160, and a storage manager 170 that runs on the server and manages server storage space. Server storage space can comprise one or more readable/writable non-volatile random access storage devices such hard disk drives, flash memory, recordable optical drives, or the like. A server storage device can be internal to the server, 180, or can be an external device, 190. An external server storage device can be connected to the server via a port, such as a universal serial bus (USB) or external Serial Advanced Technology Attachment (eSATA) port (not shown). The server storage devices can be managed as shared resources on a data network. Thereby, as shown, more than one PVR 120 can access the content stored on the server storage devices, for viewing on multiple viewing devices 110. Viewing devices can comprise television sets, computer monitors, and the like.

There are a number of ways to implement the offloader agent, and different implementations may be used for different types of PVR. For example, one type of PVR is a media center computer. This is typically a personal computer (PC) adapted for watching and recording television broadcasts, watching movies stored on a local hard drive, and the like. One example of a media center computer is a PC running Microsoft® Windows® XP Media Center Edition (MCPC) or Vista Premium or Vista Ultimate OS, which include a special user interface for interacting with recorded TV via a remote control, although other implementations are possible. In an exemplary embodiment, an offloader agent can comprise code that can read an MCPC system registry to automatically determine where recorded content is stored, such as on a local hard drive of the MCPC. The agent can then find the content, copy it to the server, and add a registry entry to the MCPC so it still knows where to find the content. Preferably, the agent can then automatically delete the original content stored on the MCPC hard drive.

Other examples of media center computers include computers running applications such as SageTV, MythTV, or the like. On such media center computers, the offload agent can comprise code that interacts with the application and/or the underlying OS to perform the same or similar functions as described above, adapted to suit the needs of the application and/or OS.

Another type of PVR is a so-called set-top box (STB), such as a Dish Network receiver with built-in PVR. Such an STB typically uses a customized OS. For example, a Dish Network STB may use a customized Linux-based OS. In an exemplary embodiment, the agent can comprise code that interacts with the Dish Network PVR code to perform the same or similar functions as described above, but can be implemented differently as needed, such as to suit the needs of the different OS and/or hardware.

A single storage manager on the server can be used to manage storage space for multiple PVRs, including PVRs of the same or different types. While each PVR can have its own offload agent, the basic operation of each agent can be the same or similar.

There are a number of ways to provide the PVR with an offload agent. The offload agent can be built into the PVR by its manufacturer. Alternatively, the offload agent can be installed. For example, installation can be accomplished for a media center computer via an Installation CD or DVD. In another embodiment, the offload agent can be automatically installed by a software update to the client-side software provided with the server. In yet another embodiment, the user can manually install the offload agent on an STB connected to the network from a PC connected to the network. Other implementations are also possible.

In an exemplary embodiment, a server can be installed on a network, such as a home network. The server can be connected without a display to the network. In conjunction with installing the server on the network, application software can be installed on one or more PCs on the network, including communication software, such as using an installation CD or DVD. The PC can then be used to configure the server over the network.

In another exemplary implementation, a manufacturer of an STB can integrate the client-side software into the STB during manufacture of the STB. For example, the client-side software can be embedded in the STB by the manufacturer as computer instructions on a ROM or other storage device. Alternatively, the manufacturer can provide a means to add client-side software via a software update. Once the client-side software is installed in the STB, the software can be used to configure the server and its interaction with the STB, such as through an STB user interface (UI) provided for that purpose. In operation, once the system is configured, there need be no further direct interaction with the software. The software can then operate as a continuously running background process. Alternatively, the software can be set up to run as a service, which might not run until requested to perform some operation.

In another exemplary embodiment, user configurable parameters can be set up as needed by the user, for example, through a UI presented by the offloader agent or by the PVR itself. Such user configurable parameters can include which storage locations or folders to monitor on the PVR for new recordings, how often to scan the folders, how long to wait before moving new recordings to the server, where to move the recordings on the server, whether duplicated storage such as RAID storage space should be used on the server, how to handle duplicate recordings, what to do when the server does not have sufficient storage space to store a new recording, and the like. There can also be provided a switch on the PVR, implemented in software or hardware, to turn the offload feature on and off.

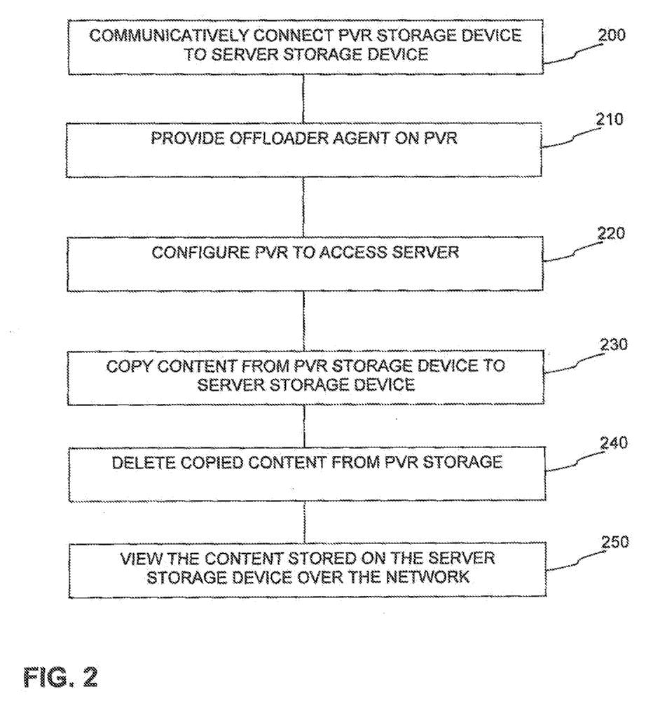

Referring now to FIG. 2, shown is a method of offloading content stored on a PVR to a server and viewing the offloaded content. In operation, a PVR storage device is communicatively connected to a server storage device (step 200). This can be accomplished, for example, by setting up a network, such as a wired or wireless local area network (LAN), and connecting both the PVR 120 and the server 160 to the network. The PVR is provided with the offloader agent (step 210). For example, the offloader agent may be embedded in the PVR, such as in a read-only memory (ROM) or other storage device, for loading upon startup of the PVR. Alternatively, the offloader agent may be installed on the PVR by the user, or as part of the client-side components of the server.

The PVR is configured to access content on the server (step 220). For example, for a media center computer this may be done manually, or may be done automatically by the offloader agent using an application programming interface (API) to the PVR software. For an STB, configuration may be performed manually on the STB. Configuration can include identifying where recorded content will be copied.

After the system is set up, content can be copied from the PVR storage device to a server storage device (step 230). This can be accomplished by the user, such as by using a user interface provided by the offloader agent or other storage management mechanism of the PVR. Alternatively, in an embodiment, the offloader agent can cause content to be copied automatically from the PVR to the server. Preferably, after recorded content is copied to the server, it can be deleted from the PVR (step 240). Again, this can be accomplished either by the user using a user interface, or can be accomplished by the offloader agent, for example, automatically deleting from the PVR content copied to the server after copying is complete. After the content is copied to the server, it can be viewed on the viewing device over the network via the PVR (step 250).

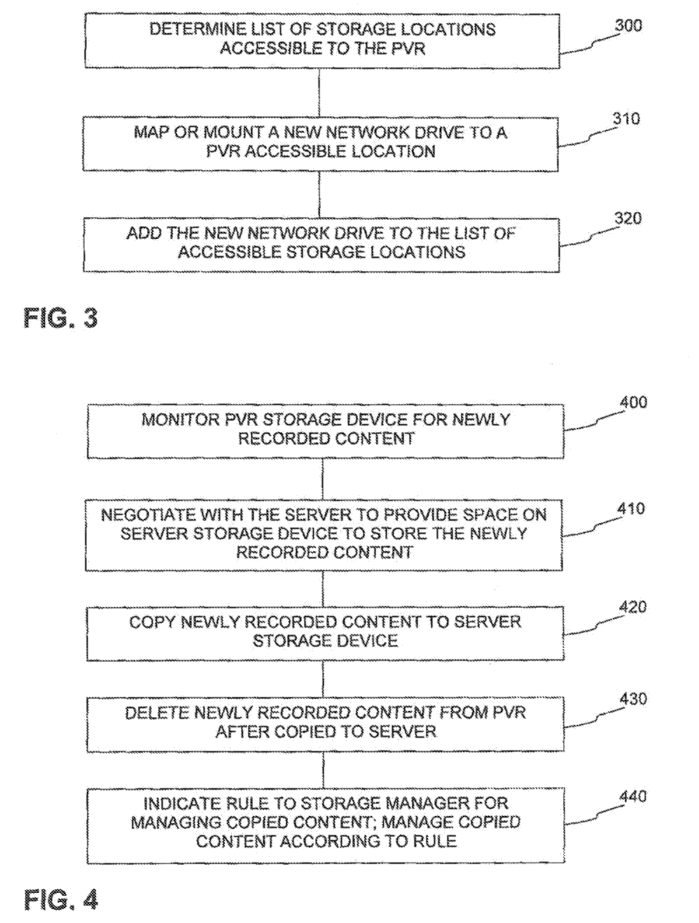

Referring now to FIG. 3, in an illustrative embodiment, as an initialization step performed upon each startup of the PVR, the offloader agent can determine a list of storage locations accessible to the PVR (step 300). For each accessible storage location, if a network drive does not exist for that storage location, such a network drive can be mapped or mounted in the file system (step 310). The offloader agent can use the PVR application programming interfaces (APIs), or registry settings in the case of an MCPC, to determine the list of storage locations for recorded shows, and to add the network location to the list of stored program locations in the PVR (step 320).

Referring now to FIG. 4, shown is a method of managing newly recorded content. The offloader agent can monitor the PVR for newly recorded content (step 400). For example, in an illustrative embodiment, the agent can monitor local storage locations for changes. When a new recording is detected, the agent can wait for completion of the recording, and then negotiate with the server to provide space for the file on the server to store the newly recorded content (step 410). The offloader agent can then copy the newly recorded content to the server (step 420), such as by a background copy of the file to the server. The background copy can be accomplished, for example, via a communications channel over the network, or via an out-of-band mechanism, such as using a server message block protocol (SMB/CIFS). The storage manager can manage space for multiple PVRs, and can allocate separate storage locations for different types of PVRs. Alternatively, the storage manager can allocate shared storage for use by similar PVRs. Preferably, when allocating shared storage for use by similar PVRs, the storage manager can be configured to disambiguate the files by source. For example, if two similar PVRs record the same show and a single storage location is used for both PVRs, then if the two copies of the same show are not disambiguated they might receive the same name. Disambiguation can be achieved, for example, by appending to the file name an indicator of the recording PVR, such as a PVR system name.

Other file naming conventions can also be implemented. For example, a filename might contain indicators of one or more parameters of the recording, such as appending an H for high definition or an S for standard definition. As another example, a P can indicate a permanent recording never to be automatically deleted, and a T can indicate a transient recording that can be deleted when additional space is needed. Preferably, the server can be configured to delete the oldest transient file to make room for new recordings as needed.

Once the file has been successfully copied and appropriately named, the agent can delete the original file, which would now be a duplicate (step 430). Because the PVR sees the remote files as extensions of the local recording space, it can manage the accessibility and longevity of those files, for example, handling automatic deletion of files marked as “delete after viewing”. In addition, the offloader agent can indicate one or more rules to the storage manager for managing the copied content, and the storage manager can manage the copied content in accordance with the rules (step 440). For example, files that are managed by a “delete when space is needed” rule can be appropriately indicated to the storage manager and managed on the server.

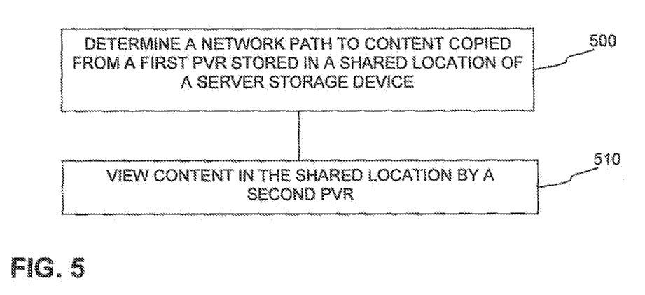

Referring now to FIG. 5, shown is a method of sharing content stored on a server. It is appreciated that, because the PVR can include network paths in its viewing lists, files copied to the server need not be copied back to the PVR for viewing. In addition, because the files can be stored in PVR-type specific shared folders, other PVRs of the same type on the network can also directly access the copied content stored in the shared folders, providing a simple sharing mechanism. After content is copied from a first PVR to a shared folder on the server, a second PVR of the same type on the network can determine a network path to the copied content in a shared location of a server storage device (step 500). The second PVR can then view the content in the shared location (step 510).

Described embodiments can provide expanded storage space limited only by the capabilities of the server. In addition, described embodiments provide for viewing of recorded content via multiple PVRs on the network.

Various modifications and variations can be made to the disclosed embodiments without departing from the spirit or scope of the invention. Thus, it is intended that the present invention cover the modifications and variations of the disclosed embodiments provided they come within the scope of the appended claims and their equivalents.

What is claimed is:

1. A system for offloading and sharing content stored on a storage device of a personal video recorder (PVR), comprising:
an offloader agent that runs on the PVR to provide content stored on a PVR storage device;
a server having at least one server storage device for receiving, storing, and serving the provided content;
a storage manager running on the server for managing storage space of the server storage device; and
a communications mechanism for connecting the PVR storage device to at least one of the server storage devices via a data communications network.

2. The system of claim 1, wherein at least one server storage device is an external hard drive directly attached to the server.

3. The system of claim 1, wherein the PVR is a personal computer (PC) operating as a media center (MCPC).

4. The system of claim 3, wherein the offloader agent is installed on the MCPC by the user.

5. The system of claim 1, wherein the offloader agent is installed on the PVR as a client-side component of the server.

6. The system of claim 1, wherein the offloader agent runs as one of a service or a background process.

7. The system of claim 1, wherein the offloader agent maps/mounts a network drive to a PVR accessible location as an initialization step on each startup of the PVR.

8. The system of claim 7, wherein the offloader agent determines a list of storage locations for recorded content, and adds the mapped/mounted network drive to the list of storage locations in the PVR.

9. The system of claim 1, wherein the offloader agent monitors the PVR storage device for newly recorded content, and negotiates with the server to provide space on a server storage device for storing the newly recorded content, and copies the newly recorded content to the provided space on the server storage device.

10. The system of claim 9, wherein the newly recorded content is copied to the server storage device using a communications channel.

11. The system of claim 9, wherein the newly recorded content is copied to the server storage device using an out-of-band mechanism.

12. The system of claim 11, wherein the out-of-band mechanism uses a server message block (SMB) protocol.

13. The system of claim 9, wherein the offloader agent deletes the newly recorded content from the PVR storage device after it has been successfully copied to the server storage device.

14. The system of claim 9, wherein the PVR indicates to the storage manager running on the server at least one management rule for use in managing the copied newly recorded content.

15. The system of claim 9, wherein a viewing list of the PVR includes at least one network path to content stored on at least one shared storage location of the server storage device.

16. The system of claim 15, wherein the content in the shared storage location can be viewed by at least one other PVR.

17. A method of offloading content stored on a storage device of a personal video recorder (PVR), comprising:
connecting the PVR storage device to a server storage device of a server via a data communications network, the server running a storage manager for managing storage space of the server storage device;
installing on the PVR an offloader agent;
configuring the PVR to access content stored on the server storage device; and
copying content stored on the PVR storage device to the server storage device via the network, using the offloader agent.

18. The method of claim 17, further comprising:
deleting the copied content from the PVR storage device after it is successfully copied to the server storage device.

19. The method of claim 17, further comprising:
viewing over the network on a viewing device connected to the PVR the content stored on the server storage device.

20. The method of claim 17, further comprising:
determining a list of storage locations accessible to the PVR for storing recorded content;
mapping/mounting a new network drive to a PVR accessible location; and
adding the mapped/mounted network drive to the list of storage locations in the PVR.

21. The method of claim 17, further comprising:
monitoring the PVR storage device for newly recorded content;
when a new recording is completed, negotiating with the server for space on a server storage device for storing the newly recorded content; and
copying the newly recorded content to the negotiated space on the server storage device.

22. The method of claim 21, further comprising
deleting the newly recorded content from the PVR storage device after it is successfully copied to the server storage device.

23. The method of claim 21, further comprising:
indicating to the storage manager by the PVR at least one management rule for use in managing the copied newly recorded content; and
managing the copied content by the storage manager in accordance with the management rule.

24. The method of claim 17, further comprising:
determining at least one network path to content viewable by the PVR stored in at least one shared location of a storage device managed by the storage manager; and
viewing content stored in the shared location via at least one other PVR.
